(19) United States
(12) Patent Application Publication
(10) Pub. No.: US 2022/0405352 A1
(43) Pub. Date: Dec. 22, 2022

(54) DIGITAL RIGHTS MANAGEMENT

(71) Applicant: HEWLETT-PACKARD DEVELOPMENT COMPANY, L.P., Spring, TX (US)

(72) Inventors: Alberto Such Vicente, Sant Cugat del Valles (ES); Josep Abad Peiro, Sant Cugat del Valles (ES); Helen Balinsky, Bristol (GB); Remy Husson, Bristol (GB)

(21) Appl. No.: 17/756,137

(22) PCT Filed: Dec. 5, 2019
(86) PCT No.: PCT/US2019/064749

§ 371 Date: May 18, 2022

(51) Int. Cl. G06F 21/10; H04L 9/00; G06F 21/60

(52) U.S. Cl. CPC G06F 21/10; H04L 9/50; G06F 21/602

(57) ABSTRACT

In some examples, there is provided a method, comprising receiving data encrypted using an encryption key, querying a digital ledger sewer for rights associated with the received data, recording, at the digital ledger server, a request to perform an access/process operation on the data, decrypting the data using a decryption key, and determining, using the rights, whether a rendering device is authorised to access and/or process the data.

### BACKGROUND

Blockchain can be used to control and manage digital rights of content shared among different workflow components. For example, files may be securely shared over a distributed network using a blockchain database. A user may request to access a file from the database and the request may be validated. The request may be granted or denied depending on file restrictions, such as a maximum use or a temporal restriction for the file. Events associated with the request may be recorded in the database.

### BRIEF DESCRIPTION OF THE DRAWINGS

Various features of certain examples will be apparent from the detailed description which follows, taken in conjunction with the accompanying drawings, which together illustrate, by way of example only, a number of features, and wherein:

FIG. 1A is a block diagram of a rights management system according to an example;

FIG. 1B is a block diagram of a rights management system according to an example;

FIG. 2A is an example flowchart of a method to determine authorisation to perform a rendering operation according to an example;

FIG. 2B is an example flowchart of a method to record in a digital ledger server a performed rendering operation according to an example;

FIG. 2C is an example flowchart of a method to perform a rendering operation according to an example;

FIG. 2D is an example flowchart of a method to generate print data and apply digital rendering rights to the print data according to an example;

FIG. 3 is a block diagram of a rendering device according to an example;

FIG. 4 is a block diagram of a rendering apparatus according to an example; and

FIG. 5 shows a block diagram of a processor associated with a memory for determining that a rendering device is authorised to perform a rendering operation on print data according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

There is provided a method for controlling and managing digital rights in a rendering device or rendering apparatus. An owner of protected digital content, which may be copyrighted, can track the use of their digital content by components or entities within a workflow. An operation performed on the protected digital content can be recorded as part of a digital ledger, such as a blockchain for example. In an example, the digital ledger can be stored on a server or remote querying server. According to an example, a cloud-based digital ledger service executing on the server can be used to encapsulate information and provide secure/controlled access of protected digital content or information in the digital ledger. In an example, secure/controlled access can comprise adding data to the digital ledger and/or reading data therefrom.

The service enables a specific workflow component to be checked or validated. For example, a raster image processor or a rendering apparatus such as a printer (which can be a two or three-dimensional printer), can have rights to perform a certain action or rendering operation on the protected digital content or protected information. The digital ledger service, executing on a server as noted above for example, enables a specific action, such as generating raster images using the protected digital content or printing or rendering a number of copies of the digital content, to be recorded by a workflow component. That is, an action or transaction can be recorded in the digital ledger, which is used as an immutable logging mechanism to record actions performed by workflow components.

According to an example, a smart contract can be used as an enforcement mechanism for entries on the digital ledger. For example, transactions can be rejected (and thus not recorded in the digital ledger by the digital ledger service) if workflow components do not follow, e.g., certain business rules. Thus, to check that an action is authorized, a workflow component can send a transaction to the server storing the digital ledger to check if an entry has been accepted. If an entry is accepted, the action can be authorized and recorded in the digital ledger server. However, if a transaction is rejected then the action is not authorized. This mechanism may be used to secure a valid execution of the workflow, since the presence of a particular piece of information in the digital ledger can mean that it has successfully passed business rule checks.

According to an example, a rendering apparatus can comprise or be in the form of a raster image processor. The rendering apparatus (with or without a raster image processor) can comprise a two-dimensional or three-dimensional printer (e.g. an additive three-dimensional printer). The printer can be configured to output rendered images of print data onto a substrate. As used herein, print data also encompasses data used in an additive manufacturing process (e.g. print data can be in the form of manufacturing data).

In an example, a rendering operation can comprise generation of raster images using the protected digital content by the rendering apparatus (using the raster image processor for example). In another example, a rendering operation can comprise performing image processing, such as color management, on print data. In another example, a rendering operation can comprise a rendering apparatus outputting a pre-determined number of prints of the digital content.

In an example, to perform a rendering operation, a workflow component, such as the rendering apparatus, can determine that it has authorisation to perform a rendering operation by querying a digital ledger for printing rights associated with the digital content to be rendered.

Thus, according to an example, there is provided a method for determining that a workflow component is authorised to perform a rendering operation on print data associated with protected digital content by querying a digital ledger for digital rendering rights associated with the print data or digital content. According to an example, there is provided a method for digital rights management performed at a print processor or printing or rendering apparatus to control processing of digital content. The processor or apparatus can check whether it has rights to access and process the digital content by querying a digital ledger for printing rights. Requests to access data and processing operations to be performed on the digital content can be recorded on the digital ledger, thereby providing end-to-end digital rights management and output traceability. This enables a copyright owner, for example, to trace workflow components that use the protected content and enable them to see how the content has been used.

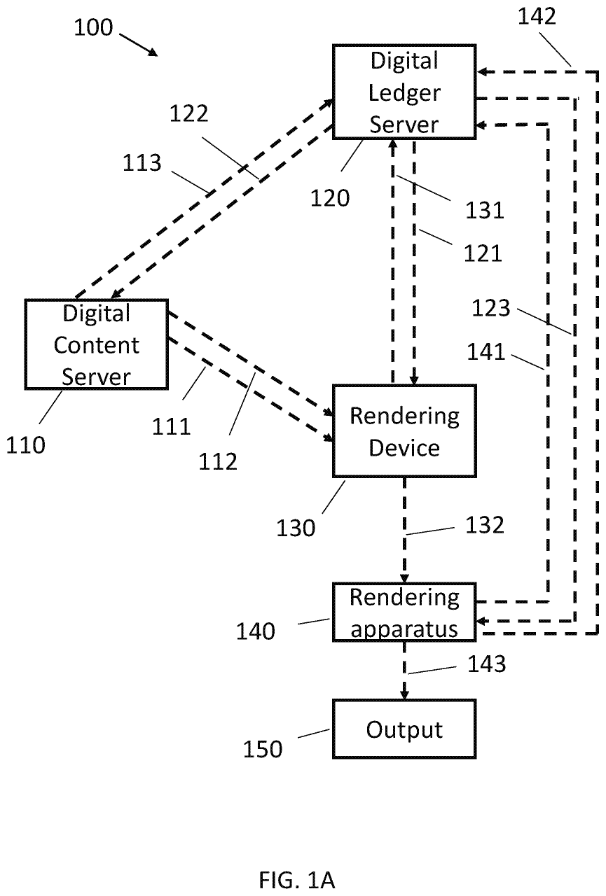

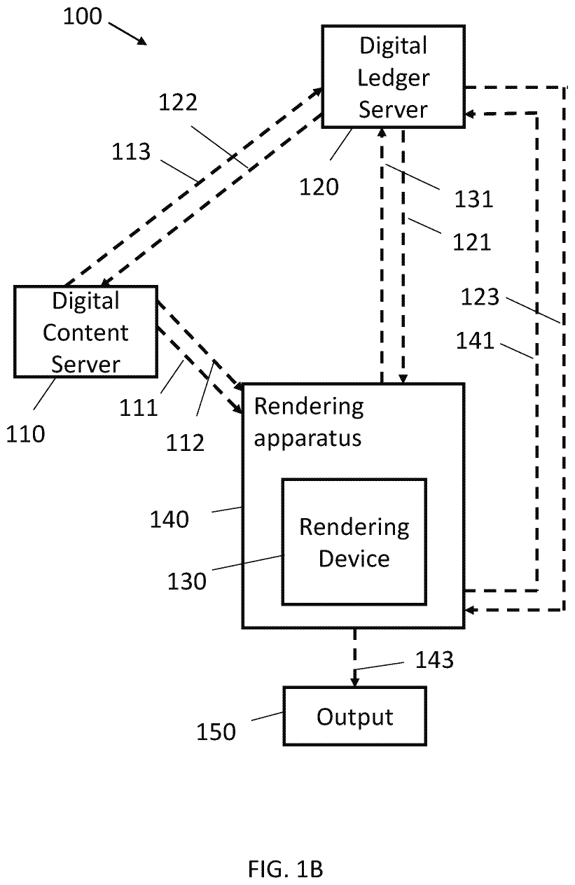

FIG. 1A is a block diagram of a rights management system 100 according to an example. The rights management system 100 is used to control and manage digital rendering rights of digital content in workflow components. The rights management system 100 comprises a rendering apparatus or device 130 and a digital ledger server 120 to store a digital ledger such as a blockchain for example, and provide a digital ledger service that enables the digital ledger to be written to/read from/queried and so on. According to an example, the rights management system 100 comprises a rendering apparatus 140 which may or may not be integrated with a rendering device 130. That is, according to an example, a rendering device 130 or raster image processor can be provided remotely from a rendering apparatus 140 or printer, and the rendering device 130 can send processed print data to the rendering apparatus 140.

In an example, the rendering device 130 confirms with the digital ledger server 120 that it has sufficient rendering rights to process the print data. The rendering apparatus 140 may separately confirm with the digital ledger server 120 that it has sufficient rendering rights to perform rendering operations on the print data or raster images received. The rendering apparatus 140 may receive protected digital content from the digital content server 110 or the rendering device 130. Regardless of which workflow component is requesting access to protected content or performing rendering operations, each of the access requests and rendering operations performed on the digital content are logged or recorded at the digital ledger server 120 by the workflow component in question.

In an example, a digital content server 110 is used to store digital content, which may be protected digital content. An owner of the digital content can upload digital content onto the digital content server 110. An owner of digital content can interact with Digital Ledger Server 120 and set rights. In an example, personalised printing materials may be provided using protected digital content, and the use of that content in the process of creating personalised material can be tracked.

According to an example, the digital content server 110 can apply rendering rights to or associate rendering rights with the print data. Such rendering rights can be recorded on the server 120, so when device 130 and apparatus 140 check the rights with server 120 it can provide them with information about the digital rights of a print job. For example, the rights be configured to regulate how many copies of particular content they are associated with can be printed, and/or on which type of printing device(s) it can be printed. The digital rights may be controlled by a protected content owner. The digital content server 110 can therefore generate print data or print jobs based on digital content that has applied digital rights management using digital rendering rights that have been recorded into a digital ledger of server 120.

According to an example, the digital content server 110 may encrypt a print data or print job to restrict access to authorised workflow components, such as for example, a specific Print Service Provider (who may be used to render a print job for example), and/or a specific printing device(s). The rendering rights information, for example to authorise printing of the print job, can be transmitted to 113 and stored in the digital ledger server 120. According to an example, print data or a print job (e.g. a portable document format (pdf) document having digital rights management applied to it) can be encrypted using an encryption key. For example, the encryption key may be a one-time key or one-time password (OTP), or a public key of a cryptographic key pair of the authorised workflow components or desired partners that have rights to access the document in question. For example, the digital content server 110 may store a list of authorised workflow components.

The digital rights management method described allows for different workflow components participating in the workflow to be uniquely identified, for example using a unique identity key or an asymmetric key pair.

According to an example, a digital rights management method enables a content owner (e.g. owner of premium content) to allow that content to be printed by a 3^{rd} party according to rights granted to that 3^{rd} party and associated with the content in question. In an example, the content owner can release content in an encrypted form and write the rights to server 120. The encrypted content is sent to an authorised device (e.g. controlled by 3^{rd} party), such as device 130 for example, which contacts server 110 to obtain the rights to perform an operation. The authorised device (e.g. device 130) sends a (e.g. blockchain) transaction request to server 120. If the request is accepted and added to the digital ledger as a transaction, the corresponding rights are granted.

According to an example, a rendering apparatus or printer can be uniquely identified using a unique identity key. For example, content server 110 can have possession of a public key from a cryptographic key pair that it can use to encrypt data. Device 130 can have possession of the corresponding private key from the key pair that it can use for decryption. The private key can be used as a unique identifier for device 130. This is similarly the case for content server 110 and apparatus 140, in which a or respective key pair(s) may be similarly provided for this combination of devices.

The rendering device or apparatus may have a decryption key, such as a one-time key or one-time password (OTP). According to an example, there is provided a mechanism to pass the one-time key from the workflow component performing the encryption to the workflow component performing the decryption of the digital content or print data. For example, the workflow component performing the decryption of data may identify with the workflow component performing the encryption to obtain the one-time password. Smart contracts, which may be stored on server 120 for example, may be used as part of the process of checking whether a workflow component has rights to access protected digital content. The digital ledger server 120 can provide the one-time password to the workflow component performing the decryption. In an example, the digital content server 110 may pass the rendering device 130 the one-time password via a secure communication channel.

According to an example, as noted above, a rendering apparatus or printer can be uniquely identified using part of a cryptographic key pair as a unique identifier for the device in question. Such a key can also be used for data decryption. According to an example, a public key of the cryptographic key pair of authorised workflow components or desired partners can be used for data encryption. An authorised workflow component in the system thus has a decryption key in the form of a private key of the cryptographic key pair.

For example, the rendering device, apparatus or raster image processor possesses a private key of the cryptographic key pair. The content server 110 has the corresponding public key. According to an example, the workflow component generating print data (for example, the digital content server or the rendering device) can encrypt the digital content or print data using the public key associated with the key pair of each one of the potential content receivers (for example, the rendering device or rendering apparatus). The authorized workflow component uses the corresponding private key of the cryptographic key pair to decrypt the encrypted data.

The rendering rights can comprise information on the workflow component or components 130, 140 that are authorised to perform a rendering operation on the print data or digital content. The rendering rights can comprise information on the rendering operations that each workflow component 130, 140 can perform using the digital content. For example, the rendering rights may comprise information on the number of copies of the digital content that a particular printer is allowed to print.

As noted above, the digital content server 110 is configured to encrypt print data associated with the digital content. As print data is likely to be very large, encrypting using asymmetric encryption may prove to be too slow. Accordingly, in an example, a new symmetric key S (e.g. AES) can be generated and provided to content server 110. The key S can be used to encrypt the print data on server 110. A public key of the authorized device (130 or 140) can be used to encrypt S. That is, print data is encrypted using a symmetric cryptography mechanism, whilst the symmetric key itself is encrypted by a public key of an authorized device. Then, the authorized device can decrypt the symmetric key using its private key, and use the symmetric key to decrypt the print data.

In an example, the digital content server 110 may store one or more lists of authorised workflow components and a respective corresponding public key for each list of authorised workflow components; the authorised workflow components of each list have a private key of the respective cryptographic key pair. Thus, encrypted print data can be transmitted 111 to a workflow component 130,140 which may or may not be authorised to perform a rendering operation on the print data. The printing rights associated with the encrypted digital content that was sent to the workflow component 130, 140, are transmitted 113 to the digital ledger server 120. The rendering rights for the print data are stored in the digital ledger server 120 or blockchain server.

According to an example, the digital content server encrypts the print data using a one-time password and shares a one-time password 112 with an authorised workflow component 130, 140. The encrypted print data is sent 111 to the rendering device 130 via a separate communication to the one-time password 112 for security.

In the example shown in FIG. 1A, the encrypted print data is transmitted 111 to a rendering device 130, such as a raster image processor. Device 130 sends a query 131 to server 120 to determine whether it is authorised. The query 131 is in the form of a blockchain transaction request asking e.g. to produce a certain number of copies of content for a print job. If, according to previous blockchain records/smart contract this is authorized the transaction request is added to the digital ledger and device 130 receives confirmation. This serves as a signal/authorization for device 130 to proceed with printing. If the transaction request from device 130 is rejected and not added to the ledger, device 130 may not proceed with printing.

If the rendering device 130 is authorised to perform a rendering operation on the print data the encrypted print data can be decrypted by the rendering device 130 using the decryption key. The digital ledger server 120 is used as a logging and querying tool to track the use of the protected digital content by the workflow components 130, 140. As such, information stored in the digital ledger server 120 may be public information that is not encrypted. In another example the information can be encrypted and made accessible to authorised parties. For example, the digital ledger server may correspond to a private or permissioned blockchain, in which data stored in the ledger may not be public to all participants (since part of the ledger may be public and the other parts not public), i.e. a form of access control may be put into place for the digital ledger server. According to another example, the data stored in the digital ledger server may be encrypted or protected by access control.

According to an example, the digital content server 110 stores a list or set of devices that are authorised to perform a rendering operation on each of the different digital contents that it stores. The authorised devices are linked to the rendering rights for each digital content.

According to an example, the rendering device 130, such as a raster image processor, has a unique identification (for example its private key) that is registered in the digital ledger server 120 by the digital content server 110.

According to an example, the rendering apparatus 140, such as a printer, has a unique identification that is registered in the digital ledger server 120 by the digital content server 110. For example, the rendering apparatus 140 may be assigned digital rendering rights authorising it to render copies of the digital content. The number of copies that the rendering apparatus 140 may be permitted to output is stored within the rendering rights at the digital ledger server.

Before the rendering device 130 is able to perform a rendering operation on the print data, a request to perform the rendering operation on the print data is recorded at the digital ledger server 120. That is, a device 130 which received a job sends a request to server 120. The request is validated and, if authorised, it is added to the digital ledger. When added to the digital ledger, device 130 receives confirmation and may decrypt the data. If, however, for whatever reason device 130 is not authorized (e.g., not the right device, already printed this data, or licence expired and so on), then the transaction request will be denied by server 120 and device 130 may not proceed with printing.

Thus, the rendering device 130 is configured to query 131 a digital ledger server 120 or network for rendering rights associated with the protected print data, in order to determine if the rendering device 130 is authorised to process or perform the rendering operation on the print data.

According to an example, a workflow component may generate a transaction to acquire the rendering rights. The workflow may be as follows: (i) the workflow component or entity 130, 140 submits a transaction request to the digital ledger server 120 to determine if it can acquire the rendering rights. Server 120 verifies the received transaction request and, if it is valid, adds it to the digital ledger where it becomes a transaction record. Device 130 then receives a confirmation from the server 120 that the transaction was accepted and that it can proceed with decrypting and printing. The transaction therefore serves both as an enforcement mechanism to acquire the rendering rights and to record use of the digital content.

According to an example, recording at the digital ledger server 120 a request to perform the rendering operation, or recording access by the workflow component 130, 140 to the rendering rights, thus comprises sending a transaction to the digital ledger server 120 to claim access to these rendering rights, i.e. the transaction becomes an attempt to claim the rendering rights. The digital ledger server 120 may apply business logic, for example through a smart contract, and the transaction may be accepted if the workflow component 130, 140 is allowed to perform the rendering operation. By querying the digital ledger server 120, a check may be performed as to whether or not the workflow component 130, 140 has successfully claimed the rendering rights, which can be used to release or withhold the decryption key. For example, the rendering rights may be represented with a token on the digital ledger server 120 or blockchain. The workflow component 130, 140 may then check with the digital ledger server 120 that it is allowed to obtain these rendering rights, and then submit a transaction claiming ownership of the token. Once (and if) ownership of the token has been acquired by the workflow component 130, 140 (that can be checked on the digital ledger server 120 by the presence of the transaction), the decryption key or one-time password may be released, thus allowing the workflow component 130, 140 to decrypt the print job. In this example, the rendering operation may be performed by the authorized workflow component 130, 140 after the workflow component 130, 140 has successfully claimed the rendering rights with the digital ledger server 120, where queries to the digital ledger server 120 are used to verify rendering rights and status of the workflow (the queries themselves do not keep track of the use of digital content). Use of the digital content is recorded in the digital ledger server 120 or blockchain via transactions such that the use of the digital content is tracked through the workflow. The history of the digital content server 120 can be checked by one or more workflow components to confirm queries or use of the digital content by other workflow components.

According to an example, workflow continuity may be enforced since if the workflow component 130, 140 has not recorded anything in the digital ledger server 120, the next participant of the workflow 140 (for example the rendering apparatus or printer) would see by querying the ledger that the rendering device 130 did not record anything and would hence refuse to perform the rendering operation or print the print job. In this example, the rendering apparatus 140 can verify that it has the right to perform the rendering operation or print by verifying that the rendering device, for example the RIP, 130 had the right to process the print job, i.e. verify that the transaction sent by the rendering device or RIP 130 claiming the rendering rights was recorded in the digital ledger server or blockchain, which means that it is valid according to workflow rules.

Both previous examples described immediately above may be combined and/or additional workflow rules may be applied. The examples described provide traceability for digital content of the print data, since the use of the print data by each workflow component 130, 140 is recorded in the digital ledger server 120.

According to an example, as an authorised device, the rendering device 130 uses its private key of the cryptographic key pair to decrypt the print data. The rendering device 130 queries 131 the digital ledger server 120 to determine if it has rights to process the print data to generate raster images. The digital ledger server 120 uses the unique identification for the rendering device 130 to provide the rendering device 130 with the information on the rendering rights 121 for the digital content in question. The query made by the rendering device 130 is transmitted 122 to the digital content server 110, which may be used by the owner of the digital content to track the use of the digital content.

The print data, once decrypted by the authorised rendering device 130, may be processed, for example by the raster image processor, to generate raster images, perform color management and/or to perform other image processing. Each rendering operation performed by the rendering device 130 is recorded in the digital server ledger 120. This record of performing each rendering operation may be transmitted 122 from the digital server ledger 120 to the digital content server 110. By logging the request to perform the rendering operation and the act of performing the rendering operation at the digital ledger server 120, all operations performed on the print data can be logged.

According to an example, the rendering device 130 may record its use of the digital content in the digital ledger server when it has performed all of its rendering operations on the print data. That is, the printer can perform all of the rendering operations without recording anything in the digital ledger server during those rendering operations, and then, when the operations are finished, it can record a summary of the actions that it has performed in a single transaction. While this reduces granularity of information, it is more compact (one transaction instead of many) which helps to improve the efficiency of the digital ledger server 120 or blockchain.

The authorised workflow components are able to open the encrypted print data and perform one or more rendering operations on the print data. According to an example, the rendering device 130 is a raster image processor which opens the print data to generate raster images. The rendering device 130 or raster image processor may perform color management on the print data.

After processing or performing the rendering operation on the print data, the raster image processor 130 can transmit 132 raster images and the information identifying the print data to the rendering apparatus 140 or printer. The rendering device 130 may encrypt the raster images and the information for identification using a second encryption key. The second encryption key may be a second one-time password or a second public key of a cryptographic key pair. This one-time password or cryptographic key pair may be different to the cryptographic key pair used between the digital content server 110 and the rendering device 130. For example, the cryptographic key pair between the digital content server 110 and the rendering device 130 may be linked to the unique identification of the rendering device 130. Similarly, the cryptographic key pair between the rendering device 130 and the rendering apparatus 140 may be linked to the unique identification of the rendering apparatus 140. The rendering device 130 may encrypt the raster images and identification information for the print data using a public key of the cryptographic key pair. The rendering device 130 sends 132 the encrypted raster images and information identifying the digital content or print data to the rendering apparatus 140. The rendering apparatus 140 uses a private key of the cryptographic key pair to decrypt the encrypted data sent by the rendering device 130. In this way, an authorised rendering apparatus is able to render or print the digital content, whereas an unauthorised workflow component cannot access the digital content.

The rendering apparatus 140 can query the digital ledger server 120 to check the rendering rights and to determine whether it is authorised to access the digital content and perform a rendering operation on the content. If the rendering apparatus 140 is confirmed by the digital ledger server 120 as being an authorised device it is able to open the encrypted data. Before performing a rendering operation, such as starting printing, the rendering apparatus 140 queries 141 the digital ledger server 120 to check the available rendering rights for the digital content. For example, there may be a limit to the number of copies of the digital content that can be printed. The request to perform the rendering operation at the rendering apparatus is recorded in the digital ledger server 120. The rendering apparatus 140 opens the encrypted data from the rendering device 130. Once the rendering apparatus 140 has confirmed the rendering rights and authorisation 123 to perform the rendering operation, the rendering apparatus 140 performs the rendering operation.

According to an example, the rendering apparatus 140 is a printer that prints a pre-determined number of copies of the digital content. Once the rendering operation has been performed by the rendering apparatus 140, the performed rendering operation is recorded in the digital ledger server 120. For example, the printer 140 records outputting a set number of prints of the digital content, i.e. the raster images are processed 143 by the rendering apparatus to print a number of copies 150 of the digital content and the print actions are recorded 142. The requested and performed rendering operation(s) may be transmitted 122 to the digital content server 110. In this way, protected digital content is tracked and use of the digital content is controlled via the digital ledger server 120 in a traceable manner.

According to an example, a failure to perform a rendering operation is recorded in the digital ledger server and a further attempt may be authorised to perform the rendering operation.

FIG. 1B is a block diagram of a rights management system 100 used to control and manage digital rendering rights of digital content according to an example. A digital ledger server 120 is used to control and manage digital rendering rights in the rendering apparatus 140 according to an example. Where the same reference numerals are used this denotes the same components and/or actions as performed with reference to FIG. 1A and will not be repeated. In the example of FIG. 1B, the rendering device 130 is embedded or comprised within the rendering apparatus 140 such that the actions of the rendering device 130 and rendering apparatus 140 are performed by the same workflow component.

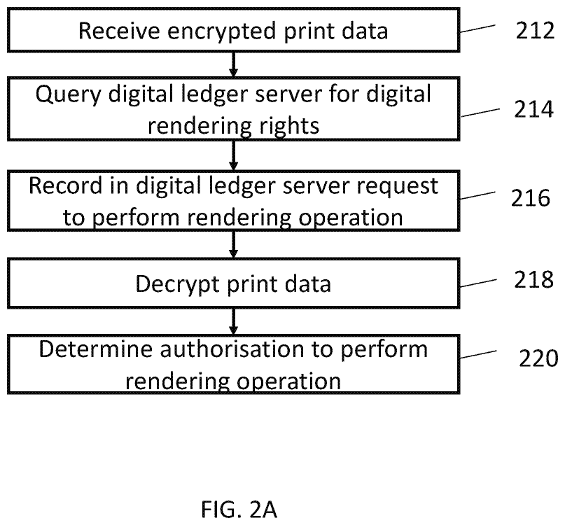

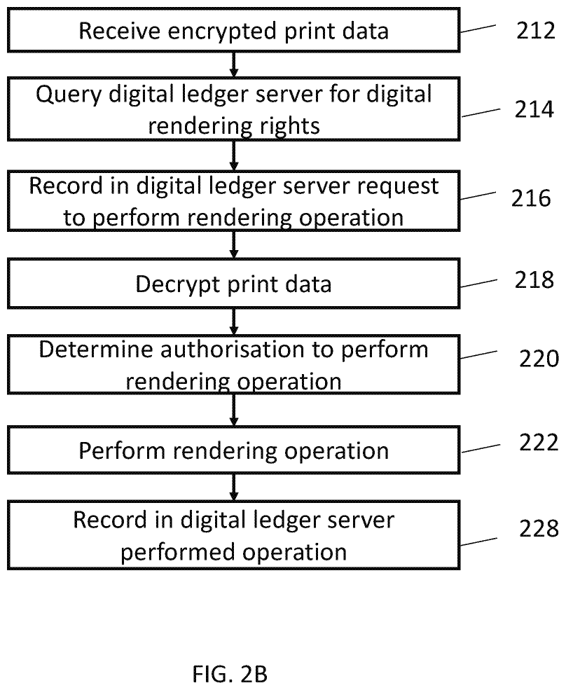

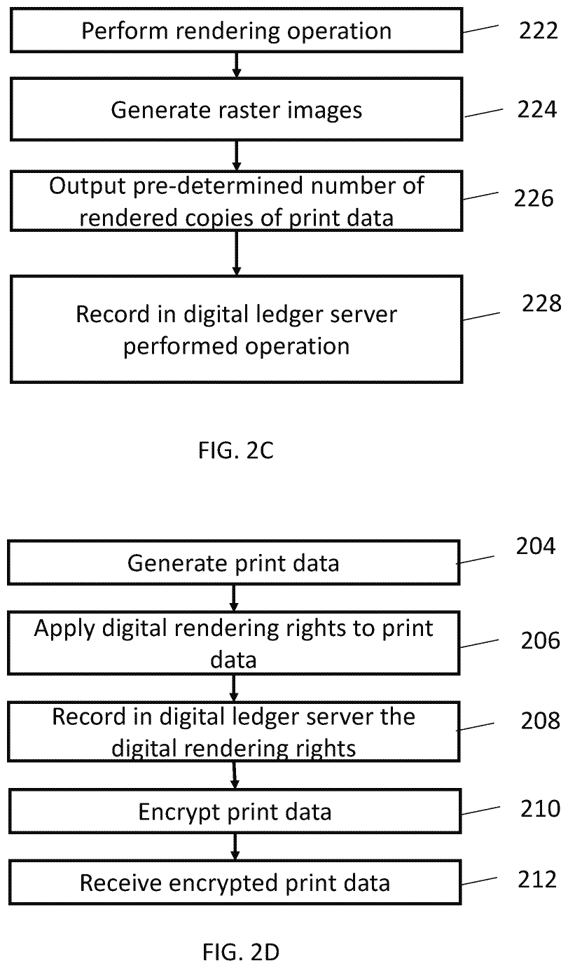

FIG. 2A is an example flowchart of a method to determine authorisation to perform a rendering operation according to an example. The method may be performed by a rendering device 130, such as a raster image processor and/or the method may be performed by a rendering apparatus 140, such as a printer. At block 212 the method comprises receiving print data encrypted using an encryption key. The print data may be encrypted by a digital content server 110. At block 214 the method comprises querying a digital ledger server 120 or blockchain server for digital rendering rights associated with the print data. At block 216 the method comprises recording at the digital ledger server 120 a request to perform a rendering operation on the print data. At block 218 the method comprises decrypting the print data using a decryption key. At block 220 the method comprises determining using the digital rendering rights that a rendering device 130, 140 is authorised to perform the rendering operation on the print data.

FIG. 2B is an example flowchart of a method to record in a digital ledger server 120 a performed rendering operation according to an example. The method may be performed by a rendering device 130, such as a raster image processor and/or the method may be performed by a rendering apparatus 140, such as a printer. Blocks 212-220 are as described with reference to FIG. 2A. At block 222 the method comprises performing the rendering operation on the print data. The rendering operation performed may relate to processing of the print data for color management and/or to generate raster images for printing, and/or may relate to rendering one or more copies of the digital content. At block 228 the method comprises recording at the digital ledger server 120 the performed rendering operation.

FIG. 20 is an example flowchart of a method to perform a rendering operation according to an example. The method may be performed by a rendering device 130, such as a raster image processor and/or the method may be performed by a rendering apparatus 140, such as a printer. At block 224 the method comprises performing the rendering operation by processing the print data to generate raster images. For example, the rendering device 130 or apparatus 140 may open the encrypted print data from the digital content server 110 to perform the rendering operation. The rendering device 130 or apparatus 140 may query the digital ledger server 120 for rendering rights for the print data. The rendering device 130 or apparatus 140 is authorised to perform the rendering operation. At block 226 the method comprises performing the rendering operation by outputting a pre-determined number of rendered copies of the print data. At block 228 the method comprises recording at the digital ledger server 120 the performed rendering operation.

FIG. 2D is an example flowchart of a method to generate print data and apply digital rendering rights to the print data according to an example. According to an example, the digital content server 110 performs the method shown in FIG. 2D. According to an example, the digital rendering rights may be provided or controlled by the owner of the digital content. For example, the owner may provide digital rights management to accompany their protected files uploaded onto the digital content server 110. At block 204 the method comprises generating the print data. At block 206 the method comprises applying digital rendering rights to the print data. At block 208 the method comprises recording at the digital ledger server the digital rendering rights. At block 210 the method comprises encrypting the print data using an encryption key, for example a one-time password or a public key of a cryptographic key pair, between the digital content server 110 and authorised workflow component 130, 140, i.e. the public key is associated with authorised rendering devices or apparatuses. At block 212 the encrypted print data 111 may be received at the rendering device 130 or rendering apparatus 140 from the digital content server 110. The rendering device 130 or apparatus 140 may decrypt the print data, or raster images, using the one-time password or private key of the cryptographic key pair.

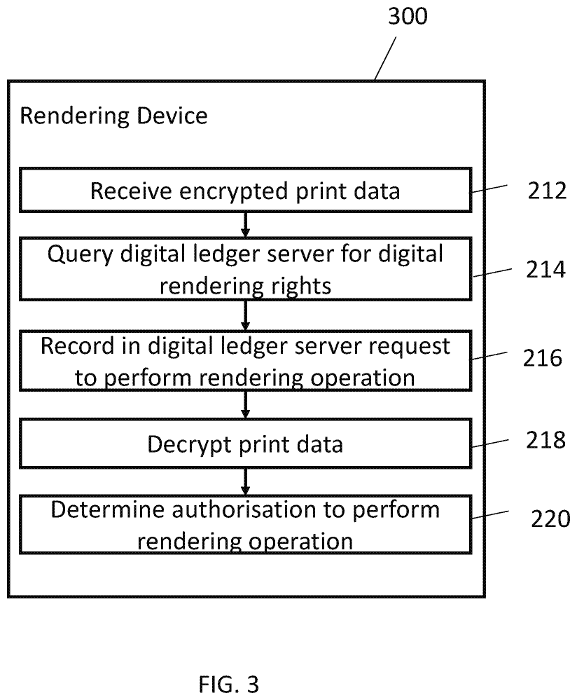

FIG. 3 is a block diagram of a rendering device according to an example. In this example, the rendering device 300 may or may not be remote from the rendering apparatus. The rendering device 300 may be a raster image processor or a printer. The rendering device 300 is configured to receive print data 212 encrypted using an encryption key. The print data may be received from a digital content server 110. The digital content server 110 may have encrypted the print data using the public key of a cryptographic key pair, which may be associated with authorised workflow components 130, 140, 300. The rendering device 300 is configured to query 214 a digital ledger server 120 for digital rendering rights associated with the print data. The rendering device 300 is configured to record 216 at the digital ledger server 120 a request to perform a rendering operation on the print data. The rendering device 300 is configured to decrypt 218 the print data using the decryption key, for example the private key of a cryptographic key pair. The rendering device 300 is configured to determine 220 using the digital rendering rights that a rendering device 300 is authorised to perform the rendering operation on the print data. The rendering device 300 may be further configured to perform the rendering operation and record at the digital ledger server 120 each performed rendering operation. According to an example, the rendering device 300 is a raster image processor configured to generate raster images using the print data.

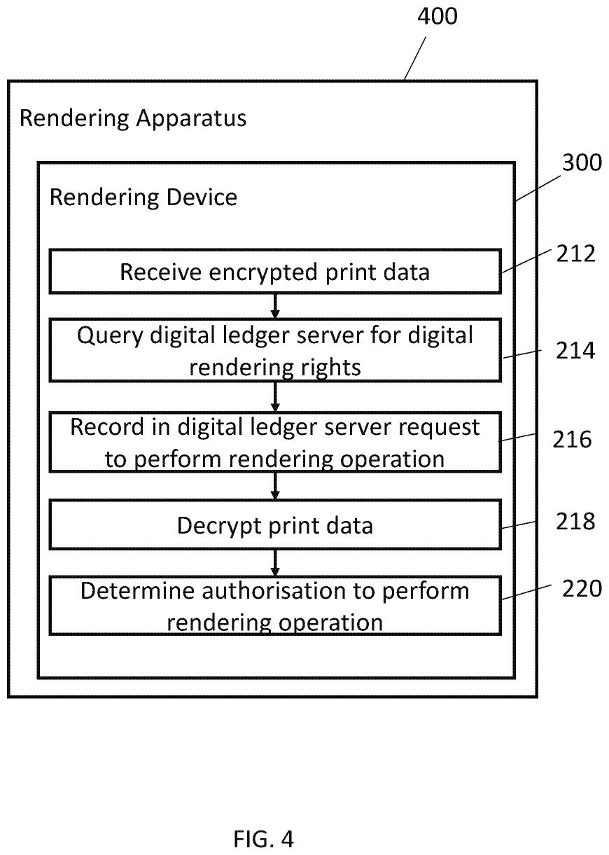

FIG. 4 is a block diagram of a rendering apparatus according to an example. The rendering apparatus 400 comprises the rendering device 300 of FIG. 3. According to an example the rendering apparatus 400 is a printer, which may be embedded with a raster image processor, configured to output 150 a rendered copy of the print data or digital content, In this example, the rendering apparatus 400 and embedded rendering device 300 perform the method of FIGS. 2A-C.

The methods for the control and management of digital rights described herein use a digital ledger server 120 to control the processing and printing of protected digital content by enabling the workflow components 130, 140, 300, 400 that participate in the workflow, such as raster image processors and printers, to be clients to the digital ledger server 120 infrastructure. In doing so, both raster image processors and printers can check that they have the rights to process and print the contents of the protected files, and register or attest the actions performed on the digital content in the digital ledger server 120.

According to an example, where the digital ledger server 120 is a blockchain server, the record of each requested and performed operation on the digital content or print data associated with the digital content cannot be tampered with. This provides traceability for copyrighted material and it can be checked by the protected content or print data owner that their digital content is used correctly, for example by authorised devices or users under license or a pay as you go service.

The rights management system 100 (digital ledger server 120 or blockchain server) stores the printing rights and provides a log of the rendering operations performed on the print data. Use of the digital content is therefore traced for those rendering devices or apparatuses that are authorised to use it.

A solution is provided that integrates a blockchain network to manage the digital rights in printing processors and printing devices. The method enables raster image processors or printing devices to check whether a user has rights to process and/or print protected content by connecting to the blockchain server or network. The method queries the blockchain server or network for the printing rights for the protected content and decodes the encrypted content. The processing and/or printing operations performed on the content are recorded on the blockchain server or network. Thus, this helps achieving end-to-end digital rights management for the protected content. As such, the method protects copyrighted content and allows a desired number of copies to be printed. The method provides traceability as all actions on the content is being recorded on the blockchain network.

The digital ledger server-based solution provided integrates a rendering device such as a raster-image processor and rendering apparatus. For example, raster image processors and printers are converted to ‘first class citizens’ of the digital rights management blockchain infrastructure, such that the use of controlled digital content can be tracked at different stages of a workflow. This tracking provides participants in the workflow and the digital content owners trusted information on how the jobs with controlled digital content have been processed and/or printed.

The methods, devices and apparatus described herein helps achieving end-to-end digital rights management. For example, copyrighted content is protected since a desired number of copies is adhered to due to imposing printing restrictions. Hence, traceability of the use of protected digital content is achieved since all of the actions that are performed on that digital content are recorded in the digital ledger server. As such, any interested party, such as the owner of the copyright for the original digital content placed in the digital content server, can trace the operations performed by each workflow component and can therefore verify that the digital rights constraints have been met.

The methods, devices and apparatus described herein may be applied to the field of content printing, such as two-dimensional or three-dimensional printing. When applied to three-dimensional printing the methods, devices and apparatus described may be used for parts manufacturing in a digital manufacturing system, such as an additive three-dimensional printer.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus (for example, a rendering apparatus or printer) may be implemented by a processor or raster-image processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

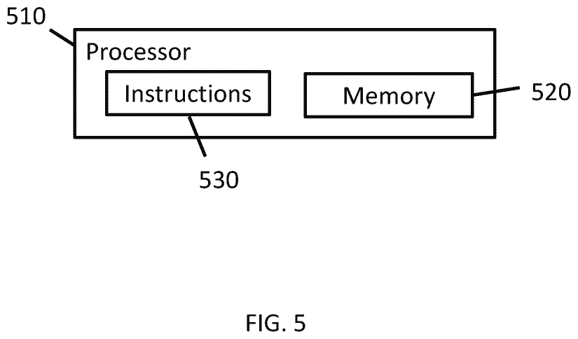

FIG. 5 shows an example of a processor 510 associated with a memory 520. The memory 520 comprises computer readable instructions 530 which are executable by the processor 510. The instructions 530 comprise:

Instructions to receive print data encrypted using an encryption key, such as a one-time password or a public key of a cryptographic key pair;

Instructions to query a digital ledger server for digital rendering rights associated with the print data;

Instructions to record at the digital ledger server a request to perform a rendering operation on the print data;

Instructions to decrypt the print data using a decryption key, such as a one-time password or a private key of the cryptographic key pair; and

Instructions to determine using the digital rendering rights that a rendering device is authorised to perform the rendering operation on the print data.

Such machine readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method, comprising:
receiving data encrypted using an encryption key;
querying a digital ledger server for rights associated with the received data;
recording, at the digital ledger server, a request to perform an access/process operation on the data;
decrypting the data using a decryption key; and
determining, using the rights, whether a rendering device is authorised to access and/or process the data.

2. A method according to claim 1, wherein the data comprises print (2D) or manufacturing (3D) data.

3. A method according to claim 2, comprising recording at the digital ledger server the performed operation.

4. A method according to claim 2, wherein performing the operation comprises processing the data to generate raster images.

5. A method according to claim 2, wherein performing the operation comprises outputting a pre-determined number of rendered copies of the data.

6. A method according to claim 1, comprising generating the data and applying the rights to the data.

7. A method according to claim 6, comprising recording at the digital edger server the rights.

8. A method according to claim 4, comprising encrypting the raster images using a second encryption key and transmitting the encrypted raster image to the rendering apparatus.

9. A method according to claim 8, comprising decrypting the raster images using a second decryption key associated with the authorised rendering apparatus.

10. A rendering device configured to:
receive data encrypted using an encryption key;
query a digital ledger server for rendering rights associated with the data;
record at the digital ledger server a request to access and/or process the data;
decrypt the data using a decryption key; and
determine, using the rendering rights, whether it is authorised to perform the operation on the data.

11. A rendering device according to claim 10, configured to:
perform the operation.

12. A rendering device according to claim 11, configured to:
record at the digital ledger server the performed operation.

13. A rendering device according to claim 10, wherein the rendering device is a raster image processor configured to generate raster images using the data,

14. A rendering apparatus comprising the rendering device according to claim 10, wherein the rendering apparatus is configured to output a rendered copy of the data.

15. A non-transitory machine-readable storage medium encoded with instructions executable by a processor, the machine-readable storage medium comprising instructions to:
receive print data encrypted using an encryption key;
query a digital ledger server for digital rendering rights associated with the print data;
record at the digital ledger server a request to perform a rendering operation on the print data;
decrypt the print data using a decryption key; and
determine using the digital rendering rights that a rendering device is authorised to perform the rendering operation on the print data.
